(19) United States
(12) Patent Application Publication
(10) Pub. No.: US 2024/0169292 A1
(43) Pub. Date: May 23, 2024

(54) SYSTEM OF INTELLIGENCE LEARNING AGENTS LEVERAGING EXPERTISE CAPTURE FOR WORK HEURISTICS MANAGEMENT

(71) Applicant: WORKDONE, INC., LOS ANGELES, CA (US)

(72) Inventor: Joseph T. ROGERS, Beverly Hills, CA (US)

(73) Assignee: WORKDONE, INC., LOS ANGELES, CA (US)

(21) Appl. No.: 18/493,783

(22) Filed: Oct. 24, 2023

Related U.S. Application Data
(63) Continuation-in-part of application No. 17/356,787, filed on Jun. 24, 2021, now abandoned.

(51) Int. Cl. G06Q 10/0633

(52) U.S. Cl. CPC G06Q 10/0633

(57) ABSTRACT

A system of intelligence learning agents with work heuristics management is disclosed, which eliminates the need for programmers through the use of machine learning mechanisms that continuously adjusts to changes to business processes over time and stays current with evolving business rules. Workers processes work as they always have with no interruptions or additional training required. A system for generating intelligent software learning agents with heuristics management is further disclosed.

### CROSS REFERENCE TO RELATED APPLICATIONS

This application claims priority under 35 U.S.C. § 120 as a continuation-in-part of U.S. patent application Ser. No. 17/356,787 entitled “SYSTEM OF INTELLIGENCE LEARNING AGENTS LEVERAGING EXPERTISE CAPTURE FOR WORK HEURISTICS MANAGEMENT” filed in the name of Rogers on Jun. 24, 2021, which claims priority under 35 U.S.C. § 120 as a continuation-in-part of U.S. patent application Ser. No. 16/568,235 entitled “SYSTEM OF INTELLIGENCE LEARNING AGENTS LEVERAGING EXPERTISE CAPTURE FOR WORK HEURISTICS MANAGEMENT” filed in the name of Rogers on Sep. 11, 2019, which claims priority under 35 U.S.C. § 119(e) to U.S. Provisional Patent Application Ser. No. 62/729,681 entitled “SYSTEM OF INTELLIGENCE LEARNING AGENTS LEVERAGING EXPERTISE CAPTURE FOR WORK HEURISTICS MANAGEMENT” filed in the name of Rogers on Sep. 11, 2018, the entirety of each of which is incorporated herein by reference; and this application further claims priority under 35 U.S.C. 120 as a continuation-in-part of U.S. patent application Ser. No. 16/455,648 entitled “SYSTEM OF IMPROVED INTELLIGENCE LEARNING AGENTS WITH HEURISTICS MANAGEMENT” filed in the name of Rogers on Jun. 27, 2019, now U.S. Pat. No. 11,625,643 issued on Apr. 11, 2023, which in turn claims priority under 35 U.S.C. § 119(e) to U.S. Provisional Patent Application Ser. No. 62/690,505 entitled “SYSTEM OF IMPROVED INTELLIGENCE LEARNING AGENTS WITH HEURISTICS MANAGEMENT” filed in the name of Rogers on Jun. 27, 2018, the entirety of each of which are incorporated herein by reference.

### TECHNICAL FIELD

The present invention relates to the field of electronic data entry. More specifically, the present invention relates to the use of artificial intelligence to automate data entry work performed by humans.

### BACKGROUND

Much time is wasted by office workers performing repetitive and recurring software-based tasks. Existing robotic and artificial intelligence (AI) process automation requires complicated and expensive programming. Moreover, when internal business rules change such programmed processes must be correspondingly changed or updated, and so even more programming and re-programming is needed.

Historically, robotic process automation required complicated expensive programming. Furthermore, when business rules change with respect to such processes, additional programming changes are then needed.

Knowledge work and data entry tasks have become highly reliant on larger-scale IT systems to facilitate larger back-office work such as transaction, process, and data management. The types of interactions include computer programs, websites, and mobile applications that all trigger responses and actions from knowledge workers. This type of work is manual and often rote for domain experts but is difficult to codify and fully automate, because it requires semi-structured and non-electronic data that domain experts must interpret and analyze. Workers must continue to perform this type of task in prior systems.

### SUMMARY

The present disclosure eliminates time wasted by humans completing repetitive office software tasks with improved software that uses machine learning (“artificial intelligence”) to learn and adopt to process changes over time without need for continual re-programming. Such software, sometimes referred to herein as “EXPERTISE CAPTURE” provides the following improvements in computer processing technologies:
Eliminates the need for maintenance by programmers through the use of machine learning mechanisms that adjusts to monitored process changes over time;
Stays current with business rules as the learning is continuous (older work heuristics are assigned expiration dates and thus automatically become obsolete as it learns); and
Allows human users to process work as they always have with no system interruptions, i.e., no additional training is required.

The present disclosure eliminates time wasted by humans in completing, for example, repetitive office software-based tasks. The improved AI functionality disclosed herein, sometimes referred to as EXPERTISE CAPTURE, eliminates the need for a continuous staff of dedicated programmers through the use of machine learning mechanisms/routines that adjust to changes over time, stay current with business rules as the learning is continuous (i.e., older heuristics are provided with automatic expiration dates and thus become obsolete as the system continues to learn), and allow users to process work as they always have with no interruptions. No additional training of personnel is required.

### BRIEF DESCRIPTION OF THE FIGURES

Further aspects of the present disclosure will be more readily appreciated upon review of the detailed description of its various embodiments, provided below, when taken in conjunction with the following Figures, of which:

FIG. 1 depicts components for generating an automated workflow task based on communications between a browser/plug-in and a data repository;

FIG. 2 is a table showing data that may be used by the components of FIG. 1;

FIG. 3 shows components interacting with one or more database repositories in conjunction with the generating of an automated workflow task in accordance with FIG. 1; and

FIG. 4 depicts an exemplary process for generating the automated workflow process.

FIG. 5 depicts flowcharts of a User Login and a Learning Agent process performed by the platform of the present disclosure; and

FIG. 6 is a representation of a user workflow process that may be performed by the platform of the present disclosure.

FIG. 7 is an example of the activity metadata captured and includes computer programs used during the data entry process

FIG. 8 is a system diagram of the various networked hardware components and data flow described herein.

FIG. 9 is a second system diagram of the various networked hardware components and data flow described herein.

### DETAILED DESCRIPTION

As stated above, one goal of the present disclosure is to eliminate the time wasted by humans completing repetitive office software tasks (e.g., data entry, order processing, and processes that are heavily dependent on procedural workflows). The improved programming embodied within the disclosed EXPERTISE CAPTURE system solves this technological problem with implementation of specially-programmed software improvements that enhance operability over and beyond that which was available in prior existing conventional computing systems.

EXPERTISE CAPTURE transparently automates repetitive tasks across various popular Software-as-a-Service (“SaaS”) platforms. EXPERTISE CAPTURE differs from what currently exists, since EXPERTISE CAPTURE learns and automates tasks by recording user (i.e., worker) usage without the need for software programming. This is an improvement on what currently exists. Current challenges around programming in a business environment are that:
Programmers are expensive, hard to find, and make mistakes.
Business process rules change frequently.
Users, typically employees, vendors, or customers, are averse to learning how to use new software systems.

EXPERTISE CAPTURE, on the other hand, provides the following improvements:
Eliminates the need for programmers through the implementation of machine learning against usage statistics,
Stays current with business rules as the learning is continuous. Older work heuristics have expiration dates,
Allows users to process work as they always have with no interruptions. No training is required.
Makes it possible to produce all manner of digital output and potentially physical output produced by users when paired with a humanoid robot.

The Disclosed Versions of EXPERTISE CAPTURE Include WORKDONE ANALYTICS and a WORK HEURISTICS Model (including Brain and Mastermind components) as described herein below.

WORKDONE ANALYTICS collects raw work and activity-type usage data and analytics and transmits over Transmission Control Protocol/Internet Protocol (TCP/IP) as an encrypted stream of data from the user's device (i.e., their Internet browser) to the WORKDONE ANALYTICS repository, which may be a cloud-hosted platform.

The WORK HEURISTICS MODEL leverages supervised machine learning to derive the work heuristics processed from the work analytics data stream stored in the repository.

The EXPERTISE CAPTURE system observes patterns in processing work and creates work heuristics that will allow an automated software agent to perform the same work. The user training the agent does not need instruction—the worker simply performs tasks as normal and the system learns and identifies the procedures and expected outcomes (“work heuristics”) to produce an “Agent.” The functions of such Agents are more fully disclosed in commonly owned co-pending U.S. Pat. No. 11,625,643 entitled “SYSTEM OF IMPROVED INTELLIGENCE LEARNING AGENTS WITH HEURISTICS MANAGEMENT,” which is incorporated herein by reference. Separate software then shows the activity of the Agent(s) on a dashboard interface. Machine learning work heuristics will generate logical conditions based on the processing of the inbound work data stream.

To implement EXPERTISE CAPTURE, it is necessary to craft software that is able to complete the requisite tasks and provide the user with the useful functionality described immediately above. All components are necessary for EXPERTISE CAPTURE to properly generate work heuristics to allow automated completion of tasks. As an optional failsafe, EXPERTISE CAPTURE allows for human approval and review to achieve a certain level of comfort in the generated heuristic. This is formally known as the “Human/Agent Benchmark Review.”

EXPERTISE CAPTURE is a precursor to Work Heuristics Management, a system which will enable humans to mix and match skills to create custom-operating agents that work without further training. EXPERTISE CAPTURE may be delineated into three components:
1. WORKDONE ANALYTICS for client-side process capture
2. WORKDONE ANALYTICS or data processing and management
3. WORK HEURISTICS Model for providing an Outcomes Generator

Client-Side Process Capture, which may be implemented as a browser plugin, represents how EXPERTISE CAPTURE collects and transmits data from the user to a repository, which is then becomes part of Data Processing and Management. Further, Data Processing and Management is the “brain” of EXPERTISE CAPTURE. It processes, synthesizes, and prepares data for analysis and interpretation in the Outcomes Generator, which is what produces output (heuristics) necessary for a human-readable workflow.

For client-side capture, as a matter of necessity, browser plugins require JAVASCRIPT to develop for virtually all graphical web browsers. This will be the primary means of communication between the client host and the EXPERTISE CAPTURE system.

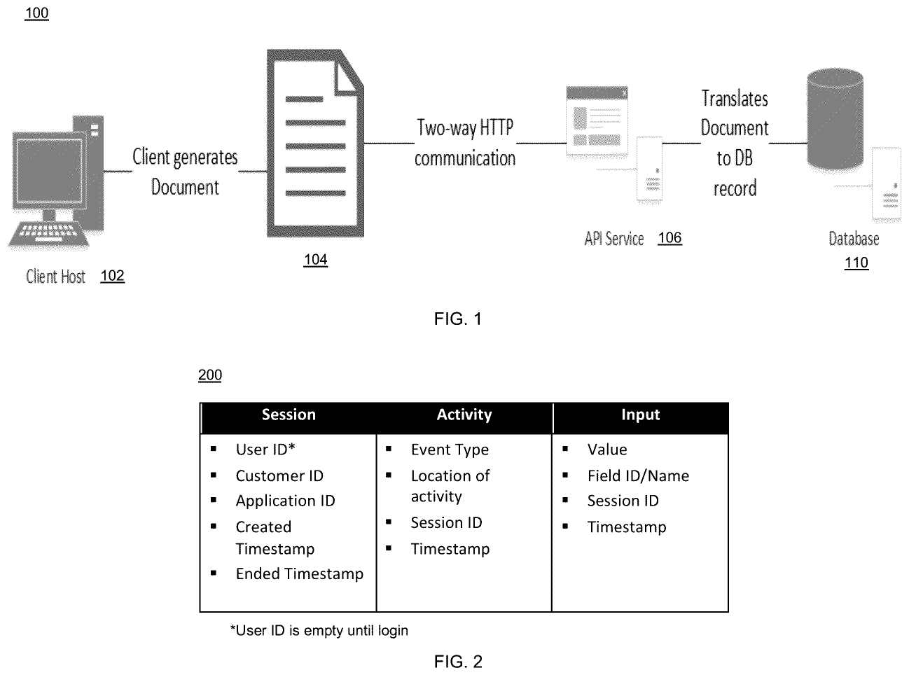

For a system 100 as demonstrated in FIG. 1, the plugin requires a configuration interface to establish authorized users and their preferences, such as supported SaaS applications (i.e., specific websites with web-based software), with authorized user and customer identifications (IDs). The components of FIG. 1 may include a client host 102, a generated heuristics document/task 102, an API Service 106 and a database repository 110.

When a user accesses a supported website, the client-side plugin prepares a Session, which establishes that a user is accessing the site and (potentially) performing work on this site. This happens by preparing data, in JavaScript Object Notation (JSON) format and using Hyper-Text Transfer Protocol (HTTP) communication to send the data from the client host 102 or device to the EXPERTISE CAPTURE system 100. This is accomplished through an HTTP-based Application Programming Interface (API) web service 106 that allows transmitting data via HTTP Uniform Resource Locators (URLs).

The API web service 106 exists inside of the EXPERTISE CAPTURE system 100. Its goal is to identify the type of data it receives and responds based on whether or not it successfully recorded the data to the EXPERTISE CAPTURE data repository, which is described in more detail below.

FIG. 2 displays a brief description of some of the exemplary documents (i.e., data) the plugin may transmits to the EXPERTISE CAPTURE data repository. The types of data the plugin transmits are as follows:
Session data (e.g., starting a web-based session via login to a support website) that may include user ID, customer ID, application ID, and beginning and ending tmestamps;
Click data (e.g., where a user clicks on an online form field to input data) or Activity such as Event Type, Location fo Activity, Session ID and Timestamps of the Activity; and
Focus/unfocus data (e.g., where a user clicks on or away from the active window where the Session began) or “Inputs” including data values, field ID, field name, Session ID and Timestamps.

For analytical convenience, EXPERTISE CAPTURE structures this data as a JSON “document,” to allow for easier, real-time streaming of data from the client's host device (e.g., employee workstation) to the EXPERTISE CAPTURE data repository.

The aim of this approach is to allow for real-time data transmission in a logical manner. The data can easily transform to relational data, while it's “document” format is more conducive to the immediate processing necessary to formulate heuristics.

Similarly, in the event that a user does not have a functioning Internet connection-a critical component for transmission—this format allows EXPERTISE CAPTURE to temporarily store the data. In order to maintain the integrity of the data, EXPERTISE CAPTURE relies on the browser's local storage mechanisms to store data temporarily. It will poll for a connection by using an HTTP “GET” request to the API to make sure a connection is established. It will try to transmit the data in real time, and, as a fallback, will wait until the Session has an “Ended” timestamp (or the like) to try again. If this fails, it will retain the data in local storage until the user can successfully make an HTTP request over the Internet.

With regard to WORKDONE ANALYTICS, meaningful, useful, and structured data being critical to establishing outcomes, a system for processing data and management is critical to EXPERTISE CAPTURE. The data transmitted in Client-Side Capture arrives via API at a data repository, specifically, a database. In order to establish communication between the client host and the EXPERTISE CAPTURE system, the API, using HTTP as the system of communication, treats any data destined for processing and management as an HTTP request. For each request, the API returns an HTTP response that illustrates if the attempt to create, retrieve, update, or delete records was successful.

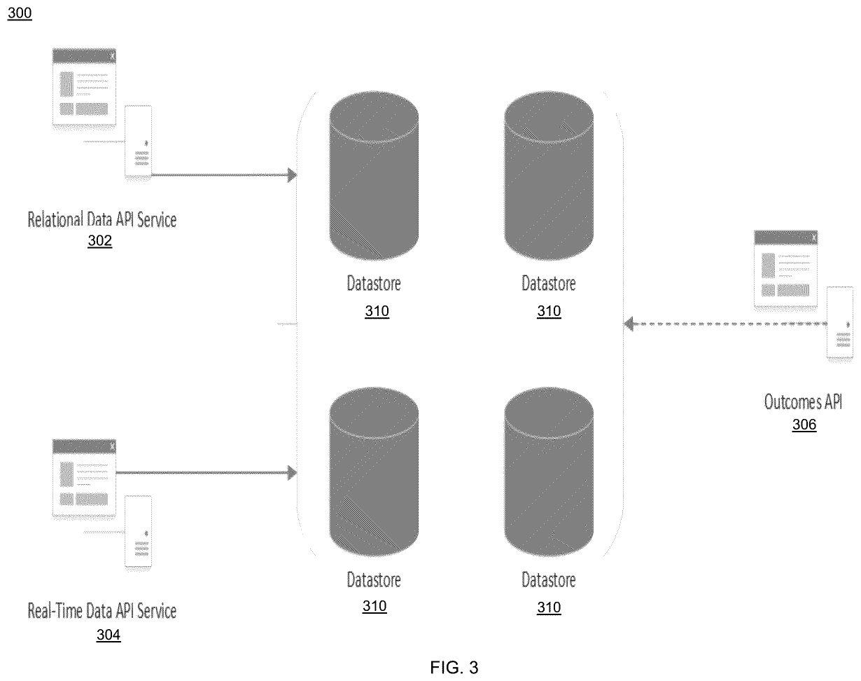

The API functions as a “service” that provides some abstraction and a standard of communication between a host that needs to perform any data creation or manipulation work without directly interfacing with any database management systems (“DBMS”) storing the data. This allows for flexibility and a singular, standardized approach to working with a DBMS with less risk of compromising the data. One example of a DBMS is shown in FIG. 3 as a collection of data stores 310. Data stored in the data stores 310 may originate from a relational data API Service 302, a real-time data API service 304 and an Outcomes Generator API 306

In order to prepare for data processing needs, search and computation are necessary utilities. As these may necessitate use from other entities, such as a client's host, these are also services for interacting with the DBMS. Computational tasks are a necessary component for generating heuristics (i.e., outcomes), and similarly search is necessary for analysis of data both in generating outcomes and in analysis of data.

The Outcomes Generator is a software service with the sole function of generating a heuristic that can be applied algorithmically to automate the problem identified in a process. It determines the steps the user has taken and determines a procedure for processing work in an integrated SaaS application.

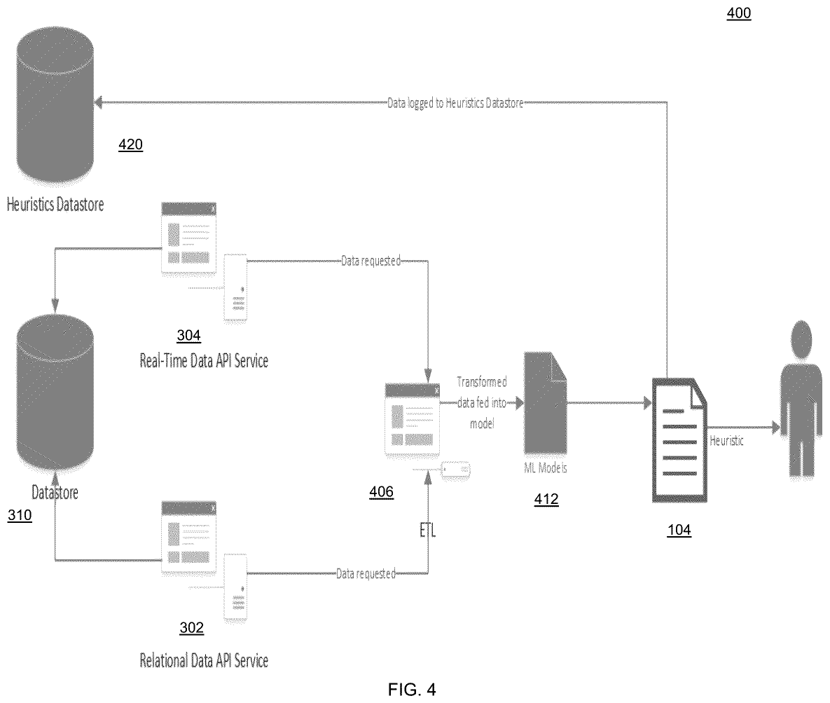

Turning to FIG. 4, the Outcomes Generator first retrieves Session, Activity, and Input documents by customer (via search mentioned above in Data Processing and Management). Using the timestamp values, the Outcomes Generator identifies:
1. Any browser tabs that the user is accessing during a Session.
2. Data (and location of data) the user extracted (e.g. copy/paste data) for use in an Input document.
3. Order of Activities and Inputs.

EXPERTISE CAPTURE utilizes utility computing to pull relevant data (per customer per application, see FIG. 4) then analyzes based on algorithmic heuristic (particularly #2 and #3 above) to create a sequence of actions 406 users make during a Session. Then, EXPERTISE CAPTURE feeds the data into machine learning models 412 to generate a common behavior by comparing actions (e.g., switching tabs to copy and paste data from a document format, such as Portable Document Format (PDF)).

Once these actions are outlined, EXPERTISE CAPTURE then makes a determination on what the source of work (e.g., the PDF used to copy and paste in a data entry task) and what values align with their respective fields in the SaaS application. EXPERTISE CAPTURE creates the steps required to perform the task. This happens initially through a basic decision algorithm then solidified with predictive analytics that can probabilistically discern the activity that's most likely occurring. With additional data for training and testing, this will become more capable of prediction of future changes through the use of artificial intelligence machine learning.

Following analysis, EXPERTISE CAPTURE uses a domain specific language (i.e., extensible markup language (XML) in this scenario) to output these steps into a file format, consequently generating the outcome (“work heuristic”) 104.

When EXPERTISE CAPTURE produces work heuristics, the output can also be applied to a business process management (“BPM”) process. EXPERTISE CAPTURE actually interfaces with a BPM service to not only create work heuristics, but also to apply these work heuristics as part of a BPM workflow upon generation. Once there is a functioning workflow, EXPERTISE CAPTURE has produced an “Agent.”

Additionally, the work heuristics are also fed to a data store 420 for continued use in EXPERTISE CAPTURE. The work heuristic itself may also become available to the user as an XML file or in a human-friendly format. This helps humans understand what the Agent will do. A human-friendly format of the work heuristics also is used in the Human/Agent Benchmark Review process mentioned above.

To use EXPERTISE CAPTURE, the user will install the EXPERTISE CAPTURE plugin (See “Client Side Capture”) to the user's web browser and continue with the user's daily workload on the supported SaaS applications manually, as described more fully in co-pending U.S. patent application Ser. No. 16/455,648 entitled “SYSTEM OF IMPROVED INTELLIGENCE LEARNING AGENTS WITH HEURISTICS MANAGEMENT,” which is incorporated herein by reference. When EXPERTISE CAPTURE has created the Agent and makes the Agent ready for user validation (See “Outcomes Generator”), EXPERTISE CAPTURE then notifies the user that they are now able to test and validate the Agent's generated procedures as a quality control measure. After the human user is satisfied with the performance of the Agent, the user can confirm the veracity of the Agent and will not have to perform the specific tasks generated by the Agent (i.e., the user-performed tasks).

Additionally, in the case of tasks that require physical movement during the course of their work, WORKDONE ANALYTICS can recreate physical movements, for example, through a humanoid robot using sensors that aid in feeding data and usage to EXPERTISE CAPTURE. Furthermore, through these efforts, it is possible that EXPERTISE CAPTURE can produce all manners of digital and potentially physical output when paired with a humanoid robot.

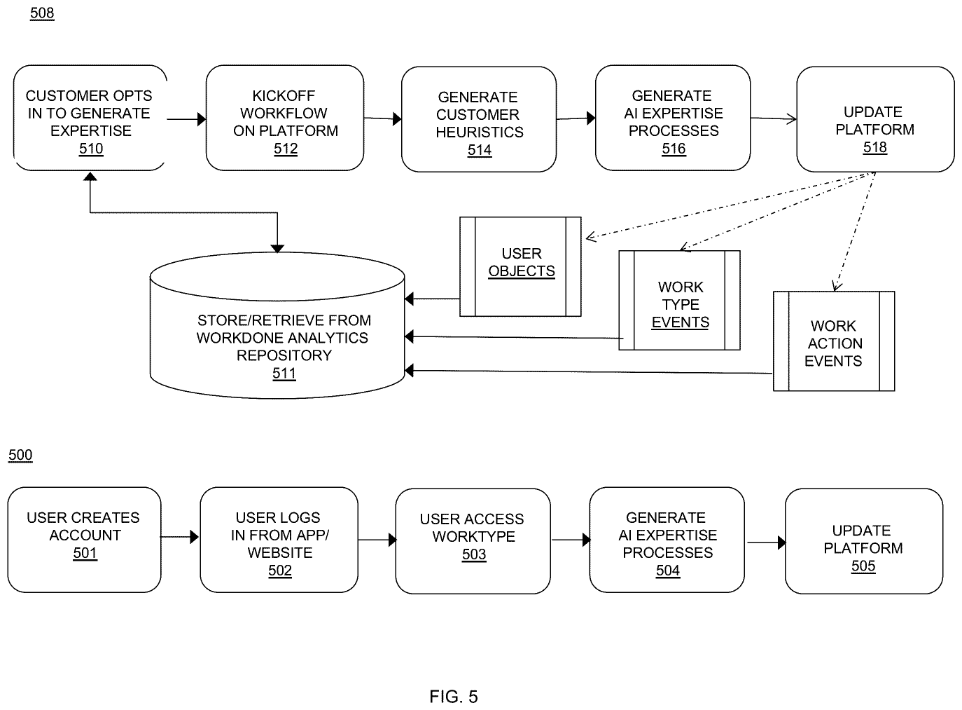

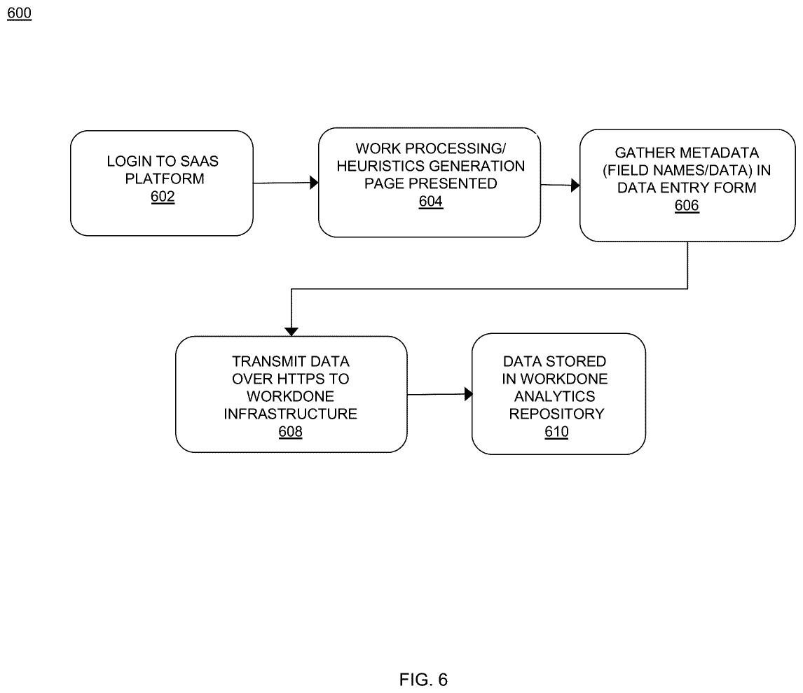

Turning now to FIGS. 5 and 6, the goal and technological improvement of the disclosed embodiments is to eliminate the time wasted by humans completing repetitive office software tasks (e.g., data entry, order processing, accounting and processes that are heavily dependent on procedural workflows). Software programming and processes that improve the functioning of computing devices, referred to herein as EXPERTISE CAPTURE, as now introduced, solves this technological problem.

EXPERTISE CAPTURE transparently automates repetitive tasks across popular Software-as-a-Service (“SaaS”) platforms in an improved manner that differs from what has previously existed. EXPERTISE CAPTURE learns and automates tasks by recording user (i.e., worker) performed tasks and usage without the need for continuous software re-programming. The process differs from well-known prior “macro” functions in word processing and the like since AI-determined shortcuts in the workflow are determined from the monitored software-based tasks performed by human users.

Current challenges around automating worker tasks in a business environment are: (i) programmers are expensive, hard to find, and make mistakes, (ii) business process rules change frequently, and (iii) users (typically employees, vendors, or customers) are typically averse to learning how to use new software systems.

EXPERTISE CAPTURE eliminates the need for programmers through the implementation of machine learning employing usage statistics; it stays current with business rules since the learning is continuous, and allows users to process work as they always have with no interruptions. No training is required. This makes it possible to produce all manner of digital output and potentially physical output produced by users when paired, for example, with a humanoid robot.

EXPERTISE CAPTURE software components may include a WORKDONE Analytics module and a Heuristics Model that acts as the brain/mastermind of the software functionality. The WORKDONE Analytics Module collects raw work- and activity-type usage data and analytics and transmits over TCP/IP as an encrypted stream of data from the user's device (i.e., their Internet browser) to the WORKDONE Analytics repository 511, which may be a cloud-hosted platform, such as CUMULUSPRO. The Heuristics Model, on the other hand, leverages supervised machine learning to derive the work heuristics processed from the work analytics data stream stored in the repository 511.

The WORKDONE Analytics Module observes patterns in processing work that will be used to create heuristics that will allow an automated software agent to perform the same work. Accordingly, the user training the “Learning Agent” does not need instruction or additional programming. A worker simply performs tasks as normal and the system learns and identifies the procedures and expected outcomes to produce the Learning Agent. Turning to FIG. 5, therein are depicted a user login process 500 and a Learning Agent process 508. The login process commences when a user creates an account with the WORKDONE platform (step 501). The user may then login to the platform from a mobile app or web browser and/or extension (step 502). The user then accesses a worktype, representing a type of task to be automated by the WORKDONE platform (step 503). The platform then generates an AI automated expertise process according to the Learning Agent process 508 (step 504). The platform is then updated and continues to refine the automated expertise process through observation of the users executions, which such updates being stored in repository 511 (step 505), after which the process 500 ends. The Learning Agent process 508 commences at step 510, when a user opts in to generate/use an automated expertise process, which may be stored, updated and retrieved from the WORKDONE Analytics Repository 511. The subject workflow is kicked off on the platform (step 512). The platform generates heuristics for the user based on recorded steps performed by one or human users who would typically execute the workflow manually (step 514). From the recorded heuristics, the platform generates an AI expertise process to replace the steps performed by human users (step 516). Finally, at step 518, the platform is updated, for example by storing generated user objects, worktype events and work action events (i.e., individual tasks performed) in the repository 511, after which the process 508 ends. In additional steps, separate software may display the activity of Learning Agent(s) on a dashboard or other graphical user interface. Machine learning heuristics will generate logical conditions based on the processing of the inbound workflow data stream that is being monitored.

In order to construct the improved software components referenced above, it was necessary to craft software that is able to complete the requisite tasks and provide the user with the useful functionality described in the foregoing. There is no existing out of the box generic functionality previously available. All components necessary for EXPERTISE CAPTURE to properly generate heuristics to allow automated completion of tasks are described herein as such. Other available components, such as a “Human/Agent Benchmark Review” are optional and meant solely for human users to achieve a level of comfort.

Additionally, EXPERTISE CAPTURE is a precursor to a Heuristics Management module (different from the Heuristics Model described herein), which is a system that will enable humans to mix and match skills to create custom-operating software Learning Agents that work without further training, as described in commonly-owned U.S. Provisional Patent Application Ser. No. 62/729,681 filed in the name of Rogers on Sep. 11, 2018, the entirety of which is hereby incorporated by reference.

In order to use EXPERTISE CAPTURE, the user will install a WORKDONE MONITOR module from EXPERTISE CAPTURE and otherwise continue with the user's daily workload manually (See FIG. 6). Turning to FIG. 6, there is depicted a process 600 for identifying work heuristics for workflow capture. The process 600 commences at step 602, where a user logs into the platform that may operate as an “SaaS.” In response, a workflow processing/heuristics generation page is presented to the user for completion (step 604). The WORKDONE platform gathers metadata, such as field names and operating data therefor, from the user entries to the workflow processing/heuristics generation page (step 606). The gathered information is transmitted over the Internet or other network to the WORKDONE platform and infrastructure (step 608). Finally, at step 610, the received data is stored in the WORKDONE analytics repository 511 for use in generating expertise processes as described herein. In additional steps, when EXPERTISE CAPTURE has created the Learning Agent and makes the Learning Agent ready for user validation, EXPERTISE CAPTURE then may notify the user to test and validate the Learning Agent's generated procedures as a quality control measure. In additional steps, after the human user is satisfied with the performance of the Learning Agent, the user can confirm the veracity of the Learning Agent and will not have to perform the specific tasks generated by the Learning Agent (i.e., the formerly manual tasks the user performed).

Additionally, in the case of tasks that require physical movement during the course of their work, WORKDONE can recreate physical movements through a humanoid robot using sensors that aid in feeding data and usage to EXPERTISE CAPTURE. Furthermore, through these efforts, it is possible that EXPERTISE CAPTURE can produce all manners of digital and potentially physical output when paired with a humanoid robot.

LISP, PYTHON, PROLOG and/or other AI programming languages may be used to implement various of the processing steps as described herein, as will be readily apparent to one of ordinary skill in the art. The specialized programming steps described herein may be particularly programmed into a computer system having a processor, memory and input/output interfaces, the operation of which is thereby enhanced and improved by the methods described herein, in a manner that is not conventionally available. The methods and processes herein are entirely implemented and executed exclusively by such specially programmed computer system.

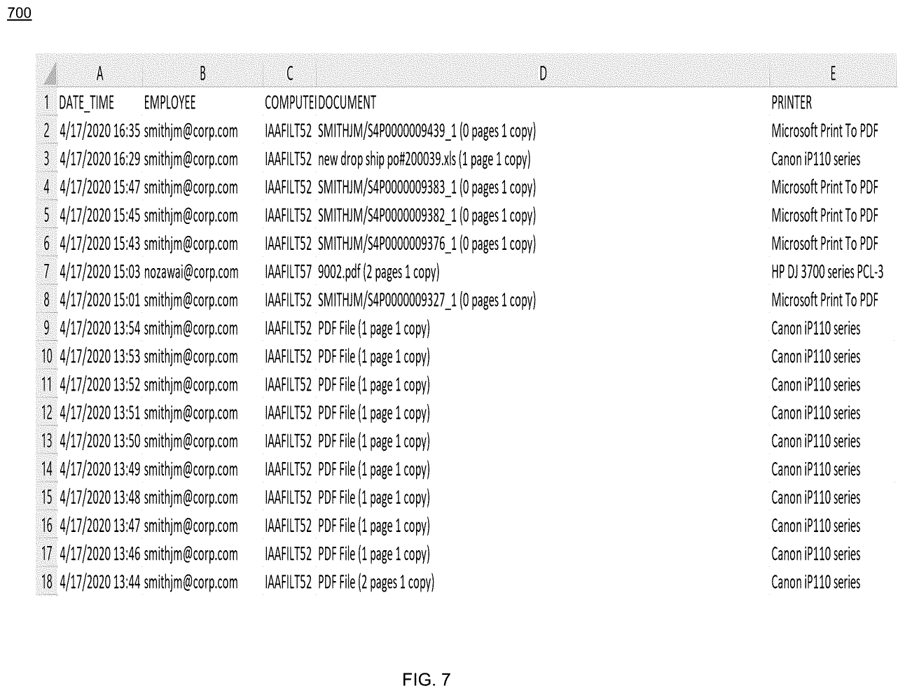

Turning now to FIGS. 7-9, a given rote manual business process, such as purchase order reconciliation, involves workers inputting data on computer workstations from invoices into business management software such as enterprise resource planning (ERP) systems. Data sources used for reconciliation include electronic mail (e-mail), word processing documents, software-based spreadsheets, Internet sites, instant messaging systems, and digital images. During this process, the worker routinely alternates between viewing the data source and the business management software to copy invoice data into the system.

The automated information processing system (“System”) includes a monitoring agent installed into the computer workstation that identifies work activity and sends information electronically about each activity into the activity data store used in the System. The System begins the data collection process after submission of activity into the activity data store. Examples of data collection include video records of worker actions, e-mail attachments, and information describing software used and time and date of activity (“activity metadata”). The System also captures computer screen text using optical character recognition (OCR) and includes the captured text with the activity metadata. After data collection, the System identifies the most appropriate enrichment action based on the type of data. E-mail attachments are sent through a classification mechanism to analyze the type of work each attachment applies to.

FIG. 7 is an example 700 of the activity metadata captured and includes computer program files used during the data entry process. An automated review algorithm assesses and analyzes the type of work performed for videos, and activity metadata is refined for additional processing in the system. The video review algorithm begins by initially processing identifying video activity metadata rows. Each video row contains a temporary location of where the video was stored at the time the System heuristic enrichment process began. A computer program runs to transport the video to cloud-based object storage, and the activity metadata is parsed. The algorithm observes the video and compares the activity data against a set of control tables to assess the possible activity the worker is engaged in. The algorithm also identifies keywords that it can compare against the label data dictionary. This data dictionary provides definitions of labels and terms that the System will encounter during video review. The System uses these definitions and control tables to produce a series of key-value pairs that define the activity that has occurred. These key-value pairs then undergo a process to establish a sequence of events and a relationship between the events. This process repeats for each video.

A similar process occurs for e-mail attachments to identify pertinent text regions in each attachment. Using OCR, the System consults the control tables and label data dictionary to create and rank the of relevance of the textual regions in attachments to the labels in the data dictionary. The most relevant ranking is used to create key-value pairs that link the regions identified with the most likely respective label. The key-value pairs can then be processed to establish a relationship between the key-value pairs and the type of activity each attachment corresponds to.

Entity creation is done to properly categorize events by activity. As workers can occasionally engage in other activities simultaneous, experience interruptions, or require additional information before proceeding, when an entity is established, the enrichment process remove events that do not pertain to the principal activity. For complex processes that require multiple steps, the enrichment process looks at potential connections between entities. The System creates entity relationships by establishing statistical correlation between entities. Highly correlated entities are then linked in a relational database table that also determines an index or entity sequence so the System can determine the order of linked activities.

In the purchase order processing example, a worker begins the process by searching for an email with the purchase order to process. The email will contain a portable document file (PDF) of the purchase order. The worker opens the PDF and then opens a program that allows the worker to enter the purchase order data into the company's ERP system. To enter the correct data in each field, the work alternates between the data entry program and the PDF to copy or scan for the section or label that corresponds to a field in the data entry program.

Once the work is complete, the worker then receives an order confirmation number that will pertain to another document or process, such as producing a Bill of Lading (BOL) for shipping goods and materials. The monitoring agent records video capturing the steps a worker takes to process the order and includes the email and attachment as part of the activity metadata. The enrichment process creates unique identifiers (GUID) for each activity. The GUIDs function as an index that help establish a relationship between, for example, data copied from purchase orders to an ERP system.

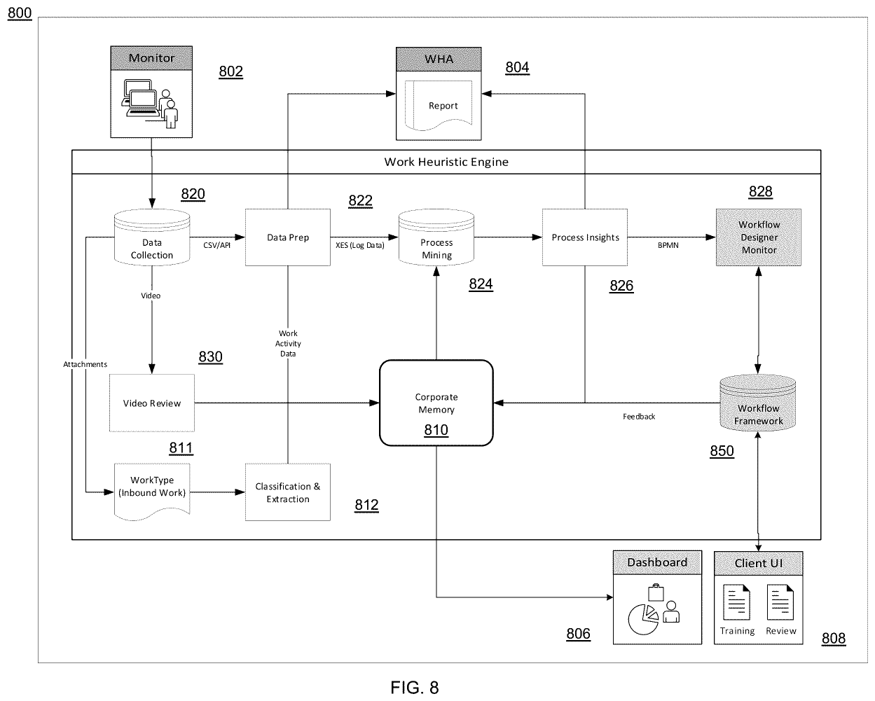

FIG. 8 demonstrates how the System 800 establishes relationships. A monitored computing device 802 sends user outputs to an activity data collection store 820. Collected textual data is sent via a comma separated value (CSV) file or the like via an API for data preparation 822 that is then stored in a process mining repository 824. Process insights 826 arising therefrom are identified and transferred to a workflow design monitor software process 828. These are developed and continuously refined as described herein to a workflow framework process 850 and then stored in the corporate memory data repository 810. Video data corresponding to worker activities monitored in the real world during activity capture are sent for video review 830 and identified user characteristics for the process are likewise stored in the corporate memory 810. Inbound work 811 is classified and extracted by work process type during a classification and extraction process 812, the results of which are then stored in the corporate memory 810. The resulting automated business processes are identified and made available for automatic execution via a user dashboard 806 and a client use interface 808 that is established for training and review.

After enrichment, the refined data is transformed for storage into a database system that the System uses as a reference, or memory 810, to activity collected previously (“Corporate Memory”). The Corporate Memory 810 is a data store that is designed to retain enriched, normalized data from several data collection sources that uses a standardized format that the System 800 can predictably use in the future without requiring re-interpretation of the previous work activity. The data is standardized as key-value pairs that can be extended or modified with minimal changes to the underlying technology.

Once the data is standardized, and the enrichment process has established work entities and entity relationships, the System 800 identifies the sequence of events from the data store containing enriched data. The System 800 then converts the sequence of events to a file that uses a specialized form of extensible Markup Language (XML) called Business Process Management Notation (BPMN). BPMN allows the System 800 to develop a computerized workflow to automate the activities performed using a business process management execution software program. The System 800 can integrate with this program through an Application Programming Interface (API) that allows the System to specify the types of emails to scan, the computer programs to use for data entry, the location of the data to enter, and any pertinent data that the System 800 will need for subsequent activities.

In invoice processing, the System 800 would specify via BPMN the e-mail accounts and e-mails to process. The System 800 would also include instructions to read e-mail attachments to identify regions relevant for processing an invoice. The BPMN file also includes instructions on the computer programs or the data entry program and the fields that correspond to labels or sections of the invoice file.

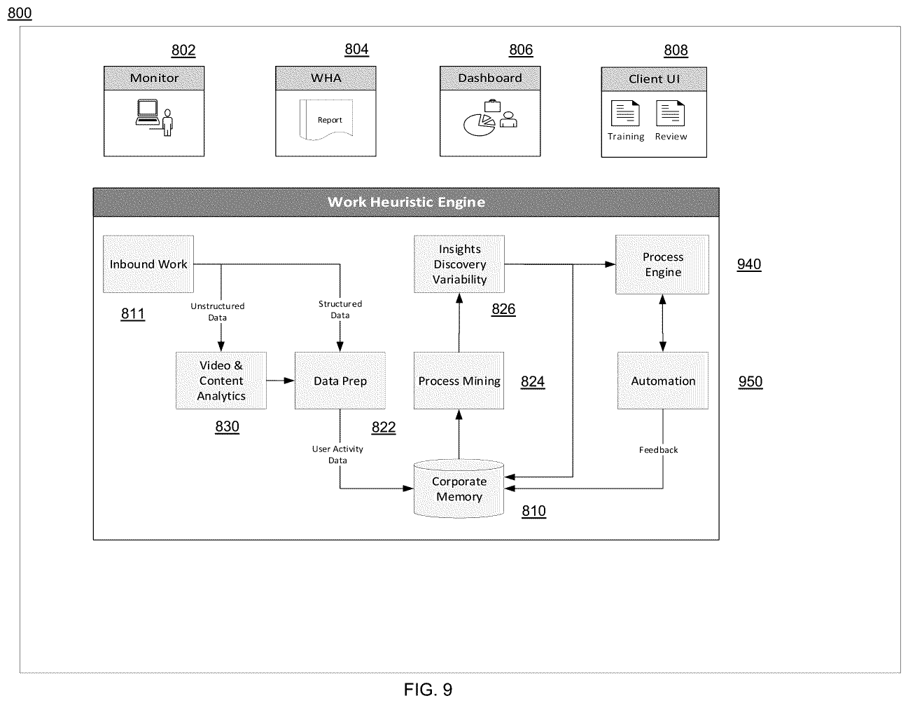

Complex, multi-step activities are also consolidated to a single BPMN file. In this scenario, the System 800 will reference entity relationships to determine relevant data that carries over to the next process in the sequence. FIG. 9 illustrates a BPMN file that includes the instructions and sequence of events that serve as a template for the workflow generated by the System 800. After refining by the Process engine 940 and automation software creation process 950, this file subsequently becomes available to users of the System, and users have the option to modify the file via a program in the System, which can display the BPMN as code or visually.

The Workflow Framework 850 of the System 800 receives user changes and feedback that returns to the System 800 for self-correction. When the System 800 makes a heuristic decision that requires correction or adjustment, this information is processed and stored within the System's Corporate Memory data store 810. This information is used to more accurately assess future activities that enter the System 800.

Although the best methodologies have been particularly described in the foregoing disclosure, it is to be understood that such descriptions have been provided for purposes of illustration only, and that other variations both in form and in detail can be made thereupon by those skilled in the art without departing from the spirit and scope thereof, which is defined first and foremost by the appended claims.

1. A system for analyzing computer-based manual tasks, the system comprising:
a server device for communicating with an activity data capture computing device having processing programs for capturing activity data of users, the server device having a corporate memory database for receiving and storing activity data captured by the activity data capture computing device and at least one automatically executable electronic business process file that is stored in at least one extensible markup language (XML) documents that relates to the activity data, the corporate memory database further for storing feedback from users for at least one of the XML documents, the server device having a processor that executes a computer program for performing process mining on the electronic business process files corresponding to the activity data based on video data corresponding to the activity data received from the activity data capture computing device, as well as stored feedback in the corporate memory database, in order to modify and correct the stored XML documents based one the feedback, the computer program further including executable code for enabling the processor of the server device to:
record a plurality of entries for a task performed on the activity data capture computing device by a user;
capture heuristics related to the plurality of entries;
generate an artificial intelligence (AI) routine to perform the task based on the plurality of entries and the heuristics;
update the AI routine with additional entries from the user during additional executions of the task;
update the AI routine based on additional executions of the task performed by additional users;
determine at least one replacement step for performing the task based on the entries, the additional entries, the additional executions and the stored feedback;
store the AI routine with the at least one replacement step in an XML document; and
provide the AI routine to users via a software as a service (SAAS) cloud platform.

2. The system of claim 1, the processing programs of the activity data capture computing device further for collecting information related to computer activities performed thereon by users, analyzing the information collected, and transmitting an analysis of the information to the server device for modifying an XML document.

3. The system of claim 2 wherein the collecting information includes identifying the activity data as part of business processes and functions that are stored in a related XML document.

4. The system as claimed in 1 wherein the identification of processes is enumerated and stored in the corporate memory database.

5. The system of claim 1 wherein the activity data can be converted into an XML document that is used to automate related business process activity.

6. The system of claim 1, the computer program further including executable code for enabling the server device to:
record physical movements of the human user performing the task;
update the AI routine with recorded physical movements; and
transmit the AI routine to a humanoid robot in a physical environment, wherein the AI routine is performed by the humanoid robot in the physical environment.

7. A system for analyzing computer-based tasks composed of:
a server device for communicating with an activity data capture computing device containing processing programs, the server device storing database programs that receive and distribute processed activity data, the database programs transforming processed data into an electronic business process file that can be refined and automatically executed; and
a computer program executed by the server device for performing heuristic evaluation and process mining on the electronic business process file based on video data therein and stores outputs in a corporate memory knowledge database, the computer program further including executable code for enabling the server device to:
record a plurality of entries for a task performed on a computer by a human user;
capture heuristics related to the plurality of entries;
generate an artificial intelligence (AI) routine to perform the task based on the plurality of entries and the heuristics;
update the AI routine with additional entries from the human user during additional executions of the task;
update the AI routine based on additional executions of the task performed by additional human users;
determine at least one replacement step for performing the task based on the entries, the additional entries and the additional executions;
store the AI routine with the at least one replacement step;
provide the AI routine to human users via a software as a service (SAAS) cloud platform;
record physical movements of the human user performing the task;
update the AI routine based on the physical movements; and
transmit the AI routine to a humanoid robot in a physical environment, wherein the AI routine is performed by the humanoid robot.

8. The system of claim 1 further comprising:
a computer device for collecting data and video information related to computer activity performed thereon, analyzing the data and video information, and updating the AI routine based on said analyzing.

9. The system of claim 8, wherein the collecting information includes identifying the task as part of a business process.

10. The system as claimed in 1, wherein the AI routine is stored in the corporate memory knowledge database.

11. The system as claimed in 1, wherein the AI routine is converted into an electronic extensible markup language (XML) document that can be used to automate a related business process.

12. A system for monitoring the correctness of an extensible markup language (XML) document, comprising:
a server device for storing XML documents;
at least one computer program for modifying and correcting XML documents; and
a database system that retains feedback from at least one user for at least one modified and corrected XML document, the at least one computer program further comprising executable code enabling the server device to:
record a plurality of entries for a task performed on a computer by a human user;
capture heuristics related to the plurality of entries;
generate an artificial intelligence (AI) routine to perform the task based on the plurality of entries and the heuristics;
update the AI routine with additional entries from the human user during additional executions of the task;
update the AI routine based on additional executions of the task performed by additional human users;
determine a replacement step for performing the task based on the entries, the additional entries and the additional executions;
store the AI routine with the replacement step in an updated XML document stored by the server device;
provide the AI routine to human users via a software as a service (SAAS) cloud platform;
record physical movements of the human user performing the task;
update the AI routine based on the physical movements; and
transmit the AI routine to a robot in a physical environment, wherein the AI routine is at least partially performed by the robot.

13. The system of claim 6 wherein the computer program further enables the human user to send feedback to update the AI routine.
